(19) United States
(12) Patent Application Publication
(10) Pub. No.: US 2019/0107268 A1
(43) Pub. Date: Apr. 11, 2019

(54) DECORATIVE LED NEON LIGHT

(71) Applicant: ZHONGSHAN LONGSHINE ELECTRICAL SCIENCE & TECHNOLOGY CO., LTD., ZHONGSHAN (CN)

(72) Inventor: ZHENG LI, ZHONGSHAN (CN)

(21) Appl. No.: 15/978,632

(22) Filed: May 14, 2018

(30) Foreign Application Priority Data
Oct. 10, 2017 (CN) 2017-21311163.7

(51) Int. Cl. F21V 17/00; F21V 21/06

(52) U.S. Cl. CPC F21V 17/007; F21Y 2115/10; F21V 21/06

(57) ABSTRACT

A decorative LED neon light includes a base case. A frame is fixedly disposed on the base case. A neon light strip is disposed on a surface of the frame. A combination formed by the frame and the neon light strip is detachably connected to the base case.

### BACKGROUND

The present disclosure relates to the field of light-emitting diode (LED) lamp technology, and in particular, to a decorative LED neon light.

LEDs, i.e. light-emitting diodes, are emerging light sources, and have, as compared with conventional light sources, advantages such as small volumes, low power consumption, long service life, and firm structures. Various lighting products that use LEDs as basic light sources keep emerging. Decorative LED neon lights are applied at various places as decoration lamps. However, an existing decorative LED neon light generally includes a base case and a frame that is welded on the base case and bent into a three-dimensional shape. A neon light strip is disposed on a surface of the frame. The base case and the frame are welded together, resulting in a relatively large packing volume for a light, making it difficult for transportation. Moreover, the light looks unattractive with the frame being welded on a surface of the base case.

### SUMMARY

To overcome the deficiency in the prior art, the present disclosure provides a decorative LED neon light that is easy to pack and transport.

A technical solution adopted by the present disclosure to resolve the technical problems is as follows:

A decorative LED neon light includes: a base case, a frame fixedly disposed on the base case, and a neon light strip disposed on a surface of the frame. A combination formed by the frame and the neon light strip is detachably connected to the base case.

The frame is constituted by a strip-shaped flexible metal and is bent into a three-dimensional form. The neon light strip is fixed on an outer surface of the frame by using glue and extends in a length direction of the frame.

A receiving cavity having an opening facing downward is disposed inside the base case. At least one penetration hole communicated with the receiving cavity is disposed on the surface of the base case. An end portion of the combination formed of the frame and the neon light strip, i.e. end portions of the frame and the neon light strip, extend into the receiving cavity through the penetration hole. A fixing structure configured to fix the end portion of the combination on the base case is further disposed inside the base case.

The fixing structure includes a hollow column disposed in the base case and correspondingly communicated with the penetration hole and a fastening bolt disposed on a side wall of the hollow column. The end portion of the combination formed by the frame and the neon light strip extends into the hollow column through the penetration hole. A threaded hole fitting the fastening bolt is formed in the side wall of the hollow column. The fastening bolt abuts against the end portion of the combination, i.e. the end portions of the frame and the neon light strip, to push the end portions of the frame and the neon light strip against an inner wall of the hollow column.

An elastic protective film covers a surface of the end portion of the combination formed by the frame and the neon light strip.

A connecting post extending downward is further disposed from a bottom side of the base case. A threaded hole is disposed inside the connecting post. A bottom cover configured to close an opening of a receiving cavity is disposed on a lower end surface of the base case. A through hole matching the connecting post is disposed in the bottom cover. A screw rod is provided to pass through the through hole and connect to the connecting post.

A wire hole is disposed on the base case or the bottom cover to allow a wire electrically connected to the neon light strip to pass through.

At least three feet are disposed on a lower end surface of the bottom cover. An anti-slip pattern is disposed on a bottom surface of each of the feet.

The present disclosure has the following beneficial technical effects:

In the decorative LED neon light having the foregoing structure, the combination formed by the frame and the neon light strip is detachably connected to the base case. The base case and the combination that is formed by the frame and the neon light strip are separately packed, thereby reducing a packing volume and transport costs.

The frame constituted by the strip-shaped flexible metal is bent into a three-dimensional form. The frame can be bent into different shapes according to different requirements, thereby enhancing the flexibility of decoration effects.

The end portions of the frame and the neon light strip pass through the base case to extend into the receiving cavity. The fixing structure configured to fix the end portions of the frame and the neon light strip on the base case is further disposed inside the base case, making the light simpler and more beautiful.

### BRIEF DESCRIPTION OF THE SEVERAL VIEWS OF THE DRAWING

The present disclosure is further described below with reference to the accompanying drawings and embodiments:

FIG. 1 is a schematic structural diagram according to the present disclosure;

FIG. 2 is a bottom-view of the schematic diagram of the embodiment in FIG. 1; and

FIG. 3 is a partial enlarged view of a portion A in FIG. 2.

### DETAILED DESCRIPTION

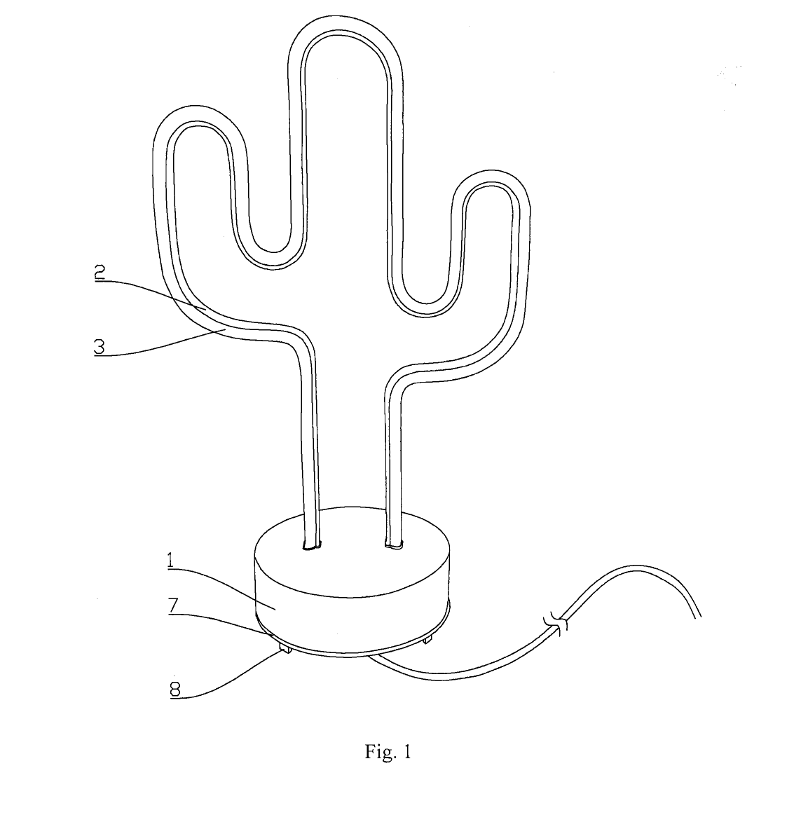

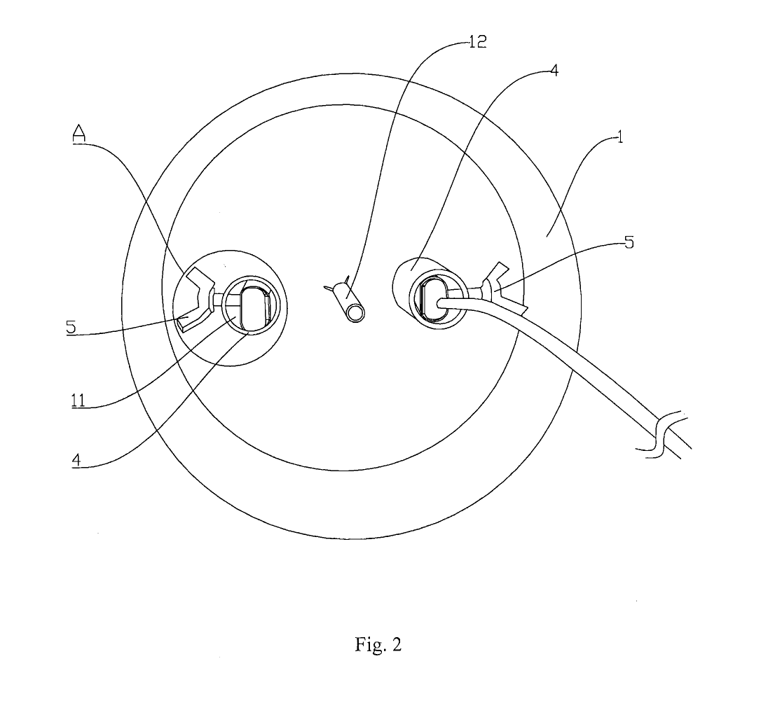

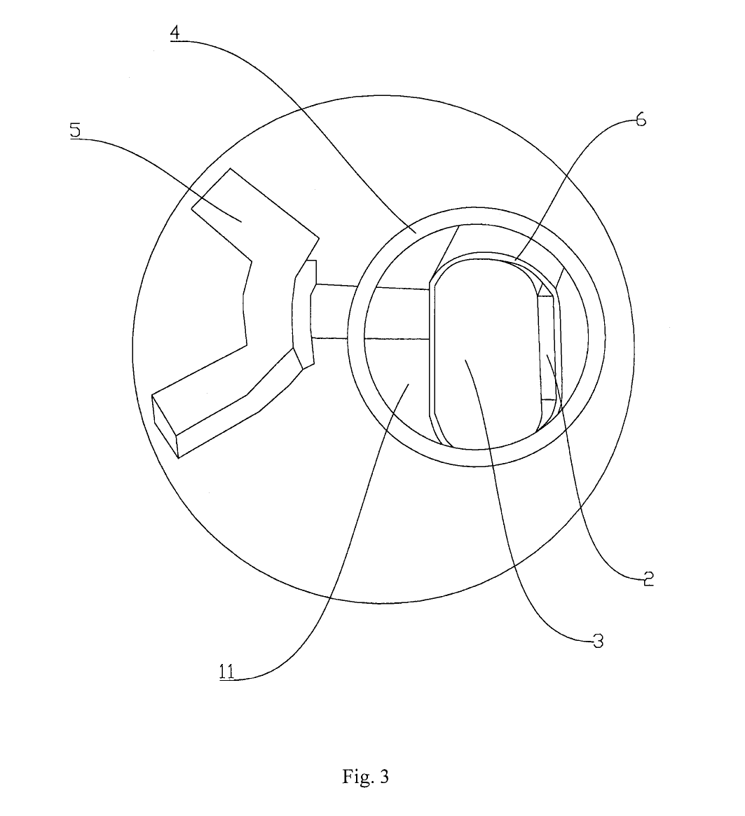

Referring to FIG. 1 to FIG. 3, as shown in the figures, a decorative LED neon light includes: a base case 1, a frame 2 fixedly disposed on the base case 1, and a neon light strip 3 disposed on a surface of the frame 2. In this embodiment, light is emitted from surfaces of the neon light strip 3 on both sides of the frame 2. A combination formed by the frame 2 and the neon light strip 3 is detachably connected to the base case 1. The base case 1 and the combination that is formed by the frame 2 and the neon light strip 3 are separately packed, thereby reducing a packing volume and transport costs.

The frame 2 constituted by a strip-shaped flexible metal is bent into a three-dimensional form. The neon light strip 3 is fixed on an outer surface of the frame 2 by using glue. The neon light strip 3 extends in a length direction of the frame 2. The frame 2 may be bent into different shapes according to different requirements. The neon light strip 3 extends in a length direction of the frame 2 to form a structure surrounding the outer surface of the frame 2, thereby enhancing the flexibility of decoration effects.

A receiving cavity having an opening facing downward is disposed inside the base case 1. At least one penetration hole 11 communicated with the receiving cavity is disposed in the surface of the base case 1. An end portion of the combination, i.e. end portions of the frame 2 and the neon light strip 3, extend into the receiving cavity through the penetration hole 11. A fixing structure configured to fix the end portions of the frame 2 and the neon light strip 3 on the base case 1 is further disposed inside the base case 1. The fixing structure is embedded inside the base case 1, avoiding the problem that a solder is exposed on the surface of the base case 1 when using a conventional welding process, and thus making the decorative LED neon light more beautiful. In this embodiment, two penetration holes 11 are disposed, and the frame 2 constituted by a strip-shaped metal sheet material is bent into a three-dimensional form looking like a cactus. Two end portions of the frame 2 are respectively and correspondingly inserted in the receiving cavity through the two penetration holes 11.

In this embodiment, the fixing structure includes a hollow column 4 disposed on the base case 1 and correspondingly communicated with the penetration hole 11, and a fastening bolt 5 disposed on a side wall of the hollow column 4. An end portion of the combination formed by the frame 2 and the neon light strip 3 extends into the hollow column 4 through the penetration hole 11. A threaded hole fitting the fastening bolt 5 is formed in the side wall of the hollow column 4. The fastening bolt 5 abuts against the end portion of the combination, i.e. the end portions of the frame 2 and the neon light strip 3 to push the end portions of the frame 2 and the neon light strip 3 against an inner wall of the hollow column 4. To prevent the fastening bolt 5 from scraping a surface of the neon light strip 3, an elastic protective film 6 is covered on a surface of the end portion of the combination formed by the frame 2 and the neon light strip 3. Here, the elastic protective film 6 is a plastic ring which covers outer surfaces of the end portion of the frame 2 and the end portion of the neon light strip 3, so as to prevent the fastening bolt 5 from damaging the surface when the fastening bolt 5 is tightly pressed against the end portion of the frame 2 and the end portion of the neon light strip 3.

In another embodiment, alternatively the fixing structure may be pins, and pin holes fitting the pins are disposed in the end portion of the frame 2 and the end portion of the neon light strip 3.

A connecting post 12 extending downward from a bottom side of the base case 1 is further disposed. A threaded hole is disposed inside the connecting post 12. A bottom cover 7 configured to close an opening of a receiving cavity is disposed on a lower end surface of the base case 1. A through hole matching the connecting post 12 is disposed in the bottom cover 7. A screw rod is provided to pass through the through hole and connect to the connecting post 12. The above connection structure is very simple and has high mounting efficiency. Since the outline of the base case 1 has a shape matching with that of the bottom cover 7, there is no need to additionally provide a positioning structure to prevent the bottom cover 7 from displacing from the base case 1.

A wire hole allowing a wire electrically connected to the neon light strip 3 to pass through is disposed on the base case 1 or the bottom cover 7. Preferably, a sealing gasket is further disposed between the wire hole and the wire and is configured to prevent a foreign object from entering the receiving cavity of the base case 1 through a gap between the wire hole and the wire.

At least three feet 8 are disposed on a lower end surface of the bottom cover 7. An anti-slip pattern is disposed on a bottom surface of each of the feet 8. In this way, the decorative neon light of the present disclosure can be stably placed on a desktop or another plane.

Preferred implementations of the present disclosure are described above in detail. Certainly, forms different from the foregoing embodiments may further be used in the present disclosure. Equivalent variations or corresponding changes made by a person skilled in the art without departing from the principle of the present disclosure shall all fall within the protection scope of the invention.

1. A decorative LED neon light, comprising:
a base case;
a frame fixedly disposed on the base case; and
a neon light strip disposed on a surface of the frame,
wherein a combination formed by the frame and the neon light strip is detachably connected to the base case.

2. The decorative LED neon light according to claim 1, wherein the frame is constituted by a strip-shaped flexible metal and is bent into a three-dimensional form, the neon light strip is fixed on an outer surface of the frame by glue, and the neon light strip extends in a length direction of the frame.

3. The decorative LED neon light according to claim 2, further comprising:
a receiving cavity having an opening facing downward, disposed inside the base case;
at least one penetration hole communicating with the receiving cavity, disposed on the surface of the base case; and
a fixing structure disposed inside the base case,
wherein an end portion of the combination formed of the frame and the neon light strip extends into the receiving cavity through the at least one penetration hole, and the fixing structure is configured to fix the end portion of the combination on the base case.

4. The decorative LED neon light according to claim 3, wherein the fixing structure comprises:
a hollow column disposed in the base case and correspondingly communicated with the at least one penetration hole,
a fastening bolt disposed on a side wall of the hollow column, and
a threaded hole fitting the fastening bolt, disposed in the side wall of the hollow column,
wherein the end portion of the combination formed of the frame and the neon light strip extends into the hollow column through the at least one penetration hole, and the fastening bolt abuts against the end portion of the combination to push it against an inner wall of the hollow column.

5. The decorative LED neon light according to claim 4, further comprising an elastic protective film covering a surface of the end portion of the combination formed of the frame and the neon light strip.

6. The decorative LED neon light according to claim 2, further comprising:
a connecting post extending downward from a bottom side of the base case;
a threaded hole disposed inside the connecting post;
a bottom cover configured to close an opening of a receiving cavity, disposed on a lower end surface of the base case;
a through hole matching the connecting post, disposed in the bottom cover; and
a screw rod provided to pass through the through hole and connect to the connecting post.

7. The decorative LED neon light according to claim 6, further comprising a wire hole disposed on the base case or the bottom cover to allow a wire electrically connected to the neon light strip to pass through.

8. The decorative LED neon light according to claim 6, further comprising:
at least three feet disposed on a lower end surface of the bottom cover; and
an anti-slip pattern disposed on a bottom surface of each of the feet.
